(19) United States
(12) Patent Application Publication
(10) Pub. No.: US 2019/0340916 A1
(43) Pub. Date: Nov. 7, 2019

(54) Mobile Personal Emergency Response System and Method of Use

(71) Applicant: Paul Graafsma, Keller, TX (US)

(72) Inventor: Paul Graafsma, Keller, TX (US)

(21) Appl. No.: 16/509,834

(22) Filed: Jul. 12, 2019

Related U.S. Application Data
(63) Continuation-in-part of application No. 15/326,480, filed on Jan. 14, 2017, now abandoned.
(60) Provisional application No. 62/161,906, filed on May 15, 2015.

(51) Int. Cl. G08B 25/01; G08B 25/10

(52) U.S. Cl. CPC G08B 25/016; G08B 25/10

(57) ABSTRACT

This invention relates generally to mobile personal emergency response systems (MPERS), and more particularly to an improved MPERS with enhanced in-building locating and user audibility.

### CROSS-REFERENCE TO RELATED APPLICATIONS

This application takes benefit of U.S. patent application Ser. No. 15/326,480 filed Jan. 14, 2017 which is a 35 U.S.C. 371 of PCT App. Ser. No. PCT/US16/30870 filed May 5, 2016 which in turn takes benefit of U.S. Prov. App. Ser. No. 62/161,906 filed May 15, 2015. This application incorporates all of the aforementioned applications in their entirety.

### FIELD OF THE INVENTION

This invention relates generally to mobile personal emergency response systems (MPERS), and more particularly to an improved MPERS with enhanced in-building locating and user audibility.

### BACKGROUND OF THE INVENTION

MPERS are very common. Generally, examples in the prior art comprise a GPS device comprising: 1) A GPS receiver; 2) A cellular transceiver (GSM, CDMA, etc.); 3) A battery; 4) A speaker and microphone for two-way communication; and, 5) A “Help” pushbutton used to request help from a monitoring dispatch center, or, answer an incoming personal or dispatcher call.

Other examples of the prior art further comprise a small RF (usually 433 Mhz or Bluetooth) wearable personal transmitter and a GPS device further comprising an RF receiver such that the wearable personal transmitter and GPS device are in wireless communication. By this means, the GPS device may be activated by actuating a switch on the wearable personal transmitter. Average transmitter range is +/−600 feet.

One problem of this example of the prior art is that many GPS devices, have a small speaker (due to their compact size) such that when the user is not near the GPS device, and it is activated via the wearable personal transmitter, the user may not hear dispatch personnel trying to communicate with them. Whether or not the user actually hears dispatch personnel is irrelevant to whether help is dispatched or not. But, the human and industry expectations are that the user must be able to hear dispatch personnel whether they can hear the user or not.

Accordingly, more recent examples of the prior art additionally comprise a standalone base station unit with its own two-way communication with a dispatch center by means of a cellular transceiver or wireline connection. The base station further comprises a “help” pushbutton, etc., like a GPS device, but, because the base station is ordinarily installed inside a building where GPS is of limited or no utility, a GPS receiver is not included. Also, the base station may, or may not, include a charging dock for a GPS device. More importantly however, base stations all include a large speaker for powerful speech reproduction when dispatcher calls are received. These systems have various methods of orchestrating the interactions between the GPS device, the wearable personal transmitter, and the base station, but in all cases, systems like these have the major disadvantage of requiring two separate telecommunications links, one for the GPS device and one for the base station.

What is needed, therefore, is an MPERs system that requires only one telecommunications link (in the GPS device); no traditional base station with its separate communications link; and a charging station with a large speaker for powerful speech reproduction selectively couplable to the GPS device.

### SUMMARY OF THE INVENTION

It is an object of the present invention to provide an MPERS system comprising a GPS device itself comprising at least: 1) A GPS receiver; 2) A cellular transceiver (GSM, CDMA, etc.); 3) A battery; 4) A speaker and microphone for two-way communication; 5) An RF receiver in communication with a wearable personal transmitter; 6) An electrical connection port allowing: a) The speaker output of the GPS device to be coupled to an amplified speaker in the charging base station; and, b) The battery of the GPS device to be recharged when connected to a charging circuit in the charging base station; and, 7) A “Help” pushbutton used to request help from a dispatch center, or, answer an incoming dispatcher call.

The present MPERS system further comprises a wearable personal transmitter itself comprising at least: 1) A battery; 2) An RF transmitter in communication with a GPS device; and, 3) A “Help” pushbutton used to request help from a dispatch center, by means of the GPS device. This wearable personal transmitter may exist in a variety of forms, e.g. a bracelet, a pendant, a waist band or belt mounted unit, a unit carried in a pocket, and so on; or, alternately, may be fashioned into another object worn or carried by the user, e.g. a pair of glasses, a cell phone, a tablet computer, etc. It will be readily apparent to those having skill in the art that the RF transmitter and receiver referred to in [110008] above and this paragraph may instead both be RF transceivers, such that the communication link between the wearable personal transmitter and the GPS device is bidirectional. One having skill in the art would recognize that this would enable an artisan in the field to construct a wearable personal transmitter capable of receiving data from the GPS device and potentially annunciating it via a speaker or displaying it via a display or other visual indicator.

The present MPERS system further comprises a charging base station itself comprising at least: 1) An amplified speaker; 2) A charging circuit with connection to mains power; and, 3) An electrical connection port allowing: a) The speaker output of the GPS device to be coupled to the amplified speaker in the charging base station; and, b) The battery of the GPS device to recharge when connected to the charging circuit in the charging base station.

The present MPERS system is used in two basic ways: 1) With the GPS device undocked from the charging base station; and, 2) With the GPS device docked in the charging base station. Undocked mode is the mode mobile users would employ, while docked mode would be used in the home, where the GPS device is charging in the charging base station.

If the GPS device is to be used undocked from the charging base station, the user affixes the GPS device to his or her person (or carries it) as they go about their routine daily activities. Simultaneously, the user also affixes the wearable personal transmitter to his or her person (or carries it). Next, to summon aid the user presses the “Help” button on either the GPS device or the wearable personal transmitter. If the user presses the “Help” button on the wearable personal transmitter, the wearable personal transmitter transmits an activation signal to the GPS device causing it to initiate a wireless voice call to the dispatch center and simultaneously transmit the current geographic coordinates derived from the GPS receiver to the dispatch center. If the user is within several feet of the GPS device, the user and dispatcher can converse as on a conventional speaker phone. If the user is not close enough to converse, but only nearby, the user can still hear the dispatcher via the speaker in the GPS device. If the user presses the “Help” button on the GPS device, the GPS device initiates a wireless voice call to the dispatch center and simultaneously transmits the current geographic coordinates derived from the GPS receiver to the dispatch center. Since the user would necessarily be in close proximity to the GPS device, the user and dispatcher can converse as on a conventional speaker phone. In either case, the dispatcher will dispatch assistance to the location derived from the GPS receiver.

If the GPS device is to be used docked in the charging base station, the user affixes only the wearable personal transmitter to his or her person (or carries it) as they go about their routine daily activities. Next, to summon aid the user presses the “Help” button on either the docked GPS device or the wearable personal transmitter. If the user presses the “Help” button on the wearable personal transmitter, the wearable personal transmitter transmits an activation signal to the docked GPS device causing it to initiate a wireless voice call to the dispatch center and simultaneously transmit a unique charging base station ID and “code/zone” (identifying the preset geographic location of the charging base station within the home and the code (reason) for the call (that the “Help” button has been depressed)) to the dispatch center. The GPS device does this because GPS signals are unreliable indoors where the charging base station will invariably be deployed. If the user is within several feet of the GPS device, the user and dispatcher can converse as on a conventional speaker phone. If the user is not close enough to converse, but in the same house or dwelling as the GPS device, the user can still hear the dispatcher via the amplified speaker in the charging base station. Alternately, if the user presses the “Help” button on the GPS device, the GPS device initiates a wireless voice call to the dispatch center and simultaneously transmits a unique charging base station ID and “code/zone” (identifying the preset geographic location of the charging base station within the home and the code (reason) for the call (that the “Help” button has been depressed)) to the dispatch center. As above, the GPS device does this because GPS signals are unreliable indoors where the charging base station will invariably be deployed. Since the user would necessarily be in close proximity to the GPS device, the user and dispatcher can converse as on a conventional speaker phone. In either case, the dispatcher will dispatch assistance to the location associated with the unique charging base station ID and zone supplied by the GPS receiver.

### BRIEF DESCRIPTION OF THE DRAWINGS

FIG. 1 is a depiction of a GPS device, a charging base station, and a wearable personal transmitter according to one embodiment of the present invention.

FIG. 2 is a block diagram of a GPS device, a charging base station, and a wearable personal transmitter according to one embodiment of the present invention.

FIG. 3 is flowchart showing a method of using one embodiment of the present invention in undocked mode where the user activates the system by pressing a button on the wearable personal transmitter.

FIG. 4 is flowchart showing a method of using one embodiment of the present invention in undocked mode where the user activates the system by pressing a button on the GPS device.

FIG. 5 is flowchart showing a method of using one embodiment of the present invention in docked mode where the user activates the system by pressing a button on the wearable personal transmitter.

FIG. 6 is flowchart showing a method of using one embodiment of the present invention in docked mode where the user activates the system by pressing a button on GPS device.

### DETAILED DESCRIPTION OF THE INVENTION

The present invention improves over the prior art by providing an improved MPERS with enhanced in-building locating functionality and audible perceptibility.

In the following description, numerous specific details regarding possible componentry are set forth (e.g., switches, speakers, RF transmitters, receivers, transceivers, GPS receivers, antennas, batteries, charging circuitry, etc.) in order to provide a thorough understanding of the invention. Those skilled in the art will recognize, however, that the invention may be practiced apart from these specific details. In other instances, details well known and widely used in the process of manufacturing consumer electronic devices (e.g., plastic injection molding, techniques for assembling electronic components, etc.) and miscellaneous components have been omitted, so as not to unnecessarily obscure the present invention.

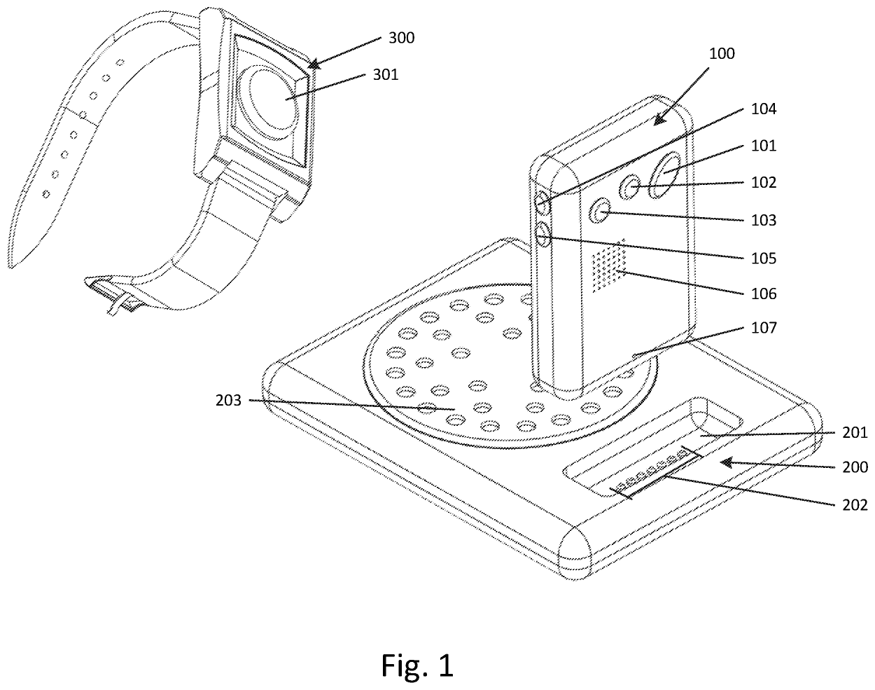

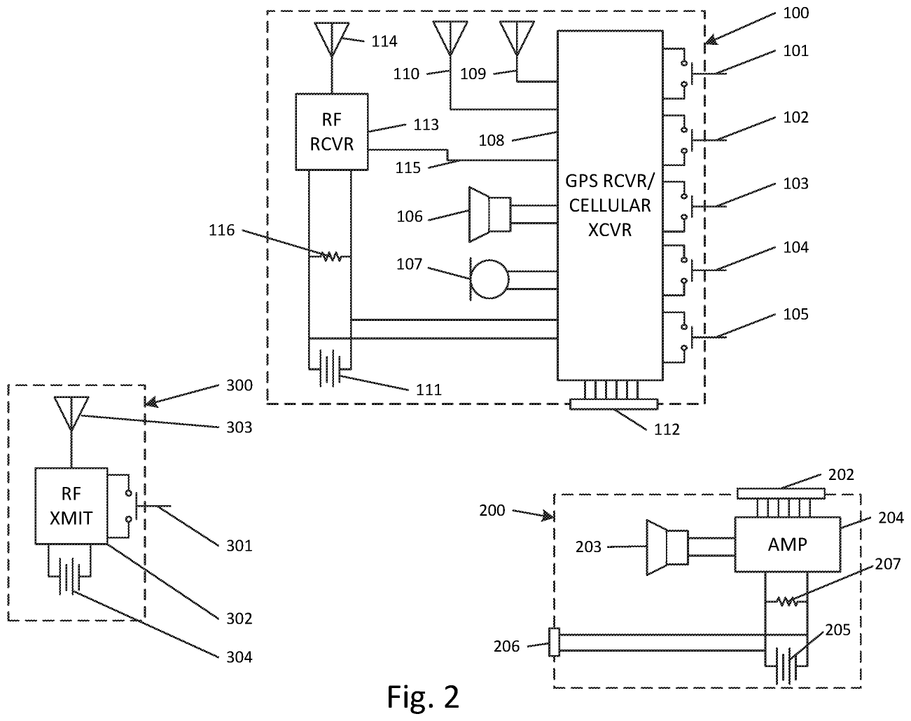

Turning now to FIGS. 1 and 2, one embodiment of the present invention is disclosed, comprising: 1) GPS device 100; 2) Charging base station 200; and, 3) Wearable personal transmitter 300.

One embodiment of GPS device 100 comprises a compact housing externally presenting help button 101, cancel button 102, programmable function button 103, volume up button 104, volume down button 105, speaker 106, microphone 107, and interface port 112. Internally, GPS device 100 comprises GPS receiver/cellular transceiver module 108 and its associated GPS antenna 110 and cellular transceiver antenna 109. GPS device 100 further comprises RF receiver 113 and its associated RF antenna 114. RF receiver 113 is electrically coupled to GPS receiver/cellular transceiver module 108 by signaling link 115. GPS device 100 is powered by battery 111.

GPS receiver/cellular transceiver module 108 further comprises a cellular transceiver. The cellular transceiver is of the type well known in the field and may conform to any one or more of the prevailing cellular transmission standards (CDMA, GSM, GPRS, UMTS, etc.) used in cellular telephones to make and receive voice calls and send and receive data. Software provided with GPS receiver/cellular transceiver module 108 typically will support various messaging formats such as text messages, multimedia messages (MMS), and the like. GPS receiver/cellular transceiver module 108 is coupled to cellular transceiver antenna 109. GPS receiver/cellular transceiver module 108 typically also comprises circuitry to control the charging of battery 111 when GPS device 100 is placed in charging base station 200.

GPS receiver/cellular transceiver module 108 further comprises a GPS receiver. It will be understood by one having skill in the art that other receivers designed for other satellite-based geolocation systems may be freely substituted (GLONASS, Galileo, COMPASS, etc.). GPS receiver/cellular transceiver module 108 is coupled to GPS antenna 110.

GPS device 100 further comprises RF receiver 113 and its associated RF antenna 114. RF receiver 113 is also powered by battery 111. RF receiver 113 may be any type commonly used for short distance RF communication (such as at 433 MHz) or to implement personal area networks (PANS) (e.g. Bluetooth). RF receiver 113 is electrically coupled to GPS receiver/cellular transceiver module 108 by signaling link 115. When help button 301 on wearable personal transmitter 300 is pressed it causes RF transmitter 302 to emit an RF signal that is received by RF receiver 113 in GPS device 100. RF receiver 113 communicates this to GPS receiver/cellular transceiver module 108 by means of signaling link 115 causing GPS receiver/cellular transceiver module 108 to initiate a call for help to the dispatch center.

GPS receiver/cellular transceiver module 108 is electrically coupled to help button 101, cancel button 102, programmable function button 103, volume up button 104, volume down button 105, speaker 106, microphone 107, and interface port 112. GPS receiver/cellular transceiver module 108 is also electrically coupled to microphone 107 and speaker 106 as would be used when making or receiving voice calls. Interface port 112 provides access to audio output from GPS receiver/cellular transceiver module 108 and access to power circuitry to charge battery 111. Battery 111 may be semi-permanently mounted inside GPS device 100 or may be user accessible.

One embodiment of charging base station 200 comprises a housing with docking port 201 providing a physically secure mounting such that GPS device 100 can be inserted in charging base station 200 such that interface port 112 of GPS device 100 can be mated to interface port 202 of charging base station 200. Charging base station 200 further comprises speaker 203 coupled to amplifier 204. Charging base station 200 also comprises battery 205 and charging port 206 to provide mains power to charging base station 200 and charge battery 205. Ordinarily, an externally mounted mains voltage to low voltage transformer or adapter may be connected to charging port 206. Battery 205 is provided to power charging base station 200 when power is unavailable via charging port 206. When GPS device 100 is docked in charging base station 200 the audio output of GPS receiver/cellular transceiver module 108 is connected to amplifier 204 (and thence to speaker 203) in charging base station 200. Simultaneously, power is supplied to GPS receiver/cellular transceiver module 108 in GPS device 100 to charge battery 111.

One embodiment of wearable personal transmitter 300 comprises RF transmitter 302 and its associated RF antenna 303. RF transmitter 302 is powered by battery 304. RF transmitter 302 may be any type commonly used for short distance RF communication (such as at 433 MHz) or to implement personal area networks (PANS) (e.g. Bluetooth). RF transmitter 302 is electrically coupled to help button 301. When help button 301 on wearable personal transmitter 300 is pressed it causes RF transmitter 302 to emit an RF signal that when received by RF receiver 113 in GPS device 100 causes GPS receiver/cellular transceiver module 108 to initiate a call for help to the dispatch center. Although wearable personal transmitter 300 is depicted in the drawings in the form of a watch those having skill in the art will readily appreciate that wearable personal transmitter 300 can be fashioned into a number of forms, including but not limited to, a pendant, a bracelet, and a clip.

Ordinarily, the improved MPERS of the present invention is provisioned for use in the following manner. First, the unique phone number associated with GPS receiver/cellular transceiver module 108 in GPS device 100 is stored in the dispatch center's database along with the identity of the user, the user's contact information, and the user's account number and account and billing information. Next, the charging base station ID of charging base station 200 and the address where charging base station 200 is physically located are stored in the dispatch center's database along with the identity of the room, apartment, or suite of the building at the supplied address where charging base station 200 is installed. These form the zone of the code/zone that is created by the system when a message is received from GPS device 100 when GPS device 100 and charging base station 200 are operating in docked mode. The code of the code/zone is transmitted by GPS device 100 and signifies the reason the message was sent. Ordinarily this would signify that either help button 101 or 301 was depressed when operating in docked mode, but those having skill in the art will recognize that other codes are conceivable, including but not limited to codes signifying status regarding batteries 111, 205, and 304, etc. To not detract from the essential elements of the present inventions, this amalgam of information, some sent by GPS device 100 and some automatically retrieved from the dispatch center's database will be referred to as the “charging base station ID-code/zone.”

Ordinarily, GPS receiver/cellular transceiver module 108 is preprogrammed to make and receive calls to and from, respectively, one dispatch number or one dispatch number in a bank of similarly functioning dispatch numbers. Thus, when the user actuates help button 101 on GPS device 100, GPS receiver/cellular transceiver module 108 initiates a call to a preprogrammed dispatch number. Next, after the dispatch center answers, one of two sets of actions occur: First, if GPS device 100 is undocked from charging base station 200 (ostensibly outside) GPS receiver/cellular transceiver module 108 annunciates the user's GPS derived lat/long location to the called dispatch number. This may be done using synthetic speech, but ordinarily the user's GPS derived lat/long location would be provided via a text message or data transmission simultaneously sent to the called dispatch number. The identity of the subscriber is known from the unique phone number and/or account number associated with GPS receiver/cellular transceiver module 108 in GPS device 100. Alternately, if GPS device 100 is docked in charging base station 200 (ostensibly inside) GPS receiver/cellular transceiver module 108 annunciates the user's unique charging base station ID-code/zone to the called dispatch number. This may be done using synthetic speech, but ordinarily the user's unique charging base station ID-code/zone would be provided via a text message or data transmission simultaneously sent to the called dispatch number. As above, the identity of the subscriber is known from the unique phone number and/or account number associated with GPS receiver/cellular transceiver module 108 in GPS device 100. In both of the above modes, cancel button 102, programmable function button 103, volume up button 104, volume down button 105 function to terminate the call, invoke a user programmed special function, raise the volume, and lower the volume, respectively.

If the dispatch center calls the user, the call is automatically terminated on GPS device 100 without intervention from the user. Next, after GPS device 100 answers, one of two sets of actions occur: First, if GPS device 100 is undocked from charging base station 200 (ostensibly outside) GPS receiver/cellular transceiver module 108 annunciates the user's GPS location to the calling dispatch number. This may be done using synthetic speech, but ordinarily the user's GPS location would be provided via a text message simultaneously sent to the calling dispatch number. Alternately, if GPS device 100 is docked in charging base station 200 (ostensibly inside) GPS receiver/cellular transceiver module 108 annunciates the user's preset unique charging base station ID-code/zone to the calling dispatch number. This may be done using synthetic speech, but ordinarily the user's unique charging base station ID-code/zone would be provided via a text message or data transmission simultaneously sent to the calling dispatch number. In both these modes the cancel button 102, programmable function button 103, volume up button 104, volume down button 105 function to terminate the call, invoke a user programmed special function, raise the volume, and lower the volume, respectively.

Since speaker 203 and amplifier 204 in charging base station 200 are activated when GPS device 100 is inserted into charging base station 200 via docking port 201 (such that amplified speech from the dispatch center is emitted from speaker 203) the user and dispatch center may converse as normal if the user is near enough to docked GPS device 100 to be detected by microphone 107. If the user is not near enough to docked GPS device 100 to be heard, the dispatch center can verbally assure the user via amplifier 204 and attached speaker 203. This allows the user to at least hear the dispatch center even if the user is not near enough to docked GPS device 100 to converse with the dispatcher. This is most useful when the user initiates a call for help by means of the help button 301 on wearable personal transmitter 300 at some distance (i.e. in another room) from docked GPS device 100.

The present MPERS system is used in two basic ways: 1) With GPS device 100 undocked from charging base station 200; and, 2) With GPS device 100 docked in charging base station 200. Undocked mode is the mode mobile users would employ, while docked mode would be used in the home, where the GPS device is charging in charging base station 200.

If GPS device 100 is used undocked from charging base station 200, the user affixes GPS device 100 to his or her person (or carries it) as they go about their routine daily activities. Simultaneously, the user may also affix wearable personal transmitter 300 to his or her person (or carries it). Next, to summon aid the user presses help button 101 on the GPS device or help button 301 on wearable personal transmitter 300.

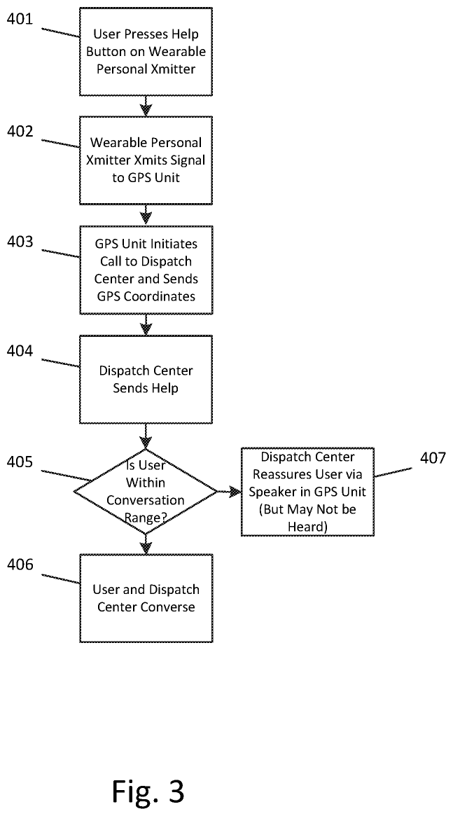

Referring now to FIGS. 1 through 3, if the user presses help button 301 on wearable personal transmitter 300, wearable personal transmitter 300 transmits an activation signal by means of RF transmitter 302 to GPS device 100 by means of RF receiver 113 (401, 402). RF receiver 113 communicates this event to GPS receiver/cellular transceiver module 108 by means of signaling link 115 causing GPS receiver/cellular transceiver module 108 to initiate a wireless voice call to the dispatch center and simultaneously transmit the current geographic coordinates derived from GPS receiver/cellular transceiver module 108 to the dispatch center. The identity of the subscriber is known from the unique phone number and/or account number associated with GPS receiver/cellular transceiver module 108 in GPS device 100 (403). Next, the dispatch center automatically sends help to the geographic coordinates derived from GPS receiver/cellular transceiver module 108 (404). If the user is within several feet of GPS device 100, the user and dispatcher can converse as on a conventional speaker phone (405, 406). If the user is not close enough to converse, but only nearby, GPS device 100 the user can still hear the dispatcher via speaker 106 in GPS device 100 (405, 407).

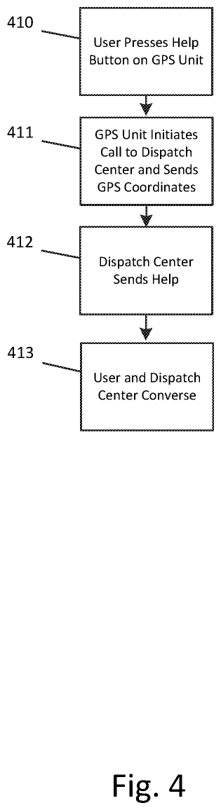

Referring now to FIGS. 1, 2, and 4, alternately, If the user presses help button 101 on GPS device 100, GPS device 100 causes GPS receiver/cellular transceiver module 108 to initiate a wireless voice call to the dispatch center and simultaneously transmits the current geographic coordinates derived from GPS receiver/cellular transceiver module 108 to the dispatch center. The identity of the subscriber is known from the unique phone number and/or account number associated with GPS receiver/cellular transceiver module 108 in GPS device 100 (410, 411). The dispatch center automatically sends help to the geographic coordinates derived from GPS receiver/cellular transceiver module 108 (412). Since the user would necessarily be in close proximity to GPS device 100, the user and dispatcher can converse as on a conventional speaker phone (413).

In either case described above, the dispatcher will automatically dispatch assistance to the location derived from GPS receiver/cellular transceiver module 108 whether the user can converse or not.

If GPS device 100 is to be used docked in charging base station 200 the user affixes only wearable personal transmitter 300 to his or her person (or carries it) as they go about their routine daily activities. Next, to summon aid the user presses help button 101 on the GPS device (if near it) or help button 301 on wearable personal transmitter 300.

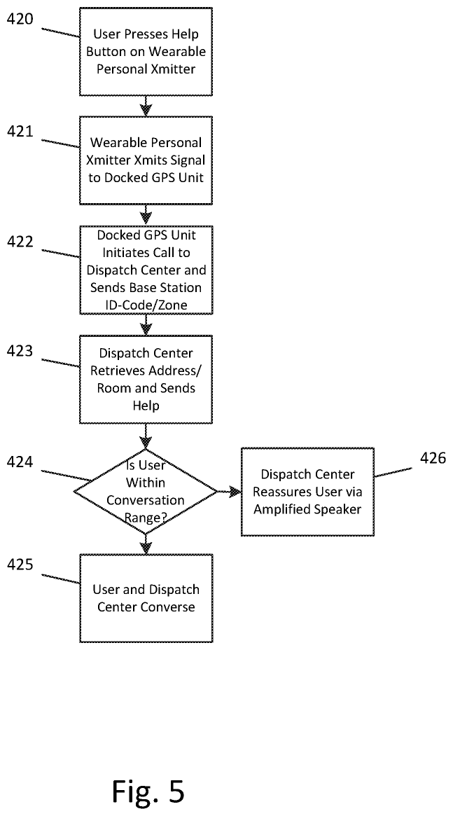

Referring now to FIGS. 1, 2, and 5, if the user presses help button 301 on wearable personal transmitter 300, wearable personal transmitter 300 transmits an activation signal by means of RF transmitter 302 to docked GPS device 100 by means of RF receiver 113 (420, 421). RF receiver 113 communicates this event to GPS receiver/cellular transceiver module 108 by means of signaling link 115 causing GPS receiver/cellular transceiver module 108 to initiate a wireless voice call to the dispatch center. The identity of the subscriber is known from the unique phone number and/or account number associated with GPS receiver/cellular transceiver module 108 in GPS device 100. In this case, docked GPS device 100 does not send current geographic coordinates derived from GPS receiver/cellular transceiver module 108. Rather, when this occurs, the database maintained at the dispatch center is accessed using the charging base station ID-code/zone to retrieve the geographic location (address) and zone (kitchen, bath, bedroom) associated with GPS receiver/cellular transceiver module 108 (422). This information is displayed to the dispatcher who then dispatches help to the displayed address referencing the displayed room (423). If the user is within several feet of GPS device 100, the user and dispatcher can converse as on a conventional speaker phone (424, 425). If the user is not close enough to converse, the user can hear the dispatcher via amplified speaker 203 in charging base station 200 (424, 426).

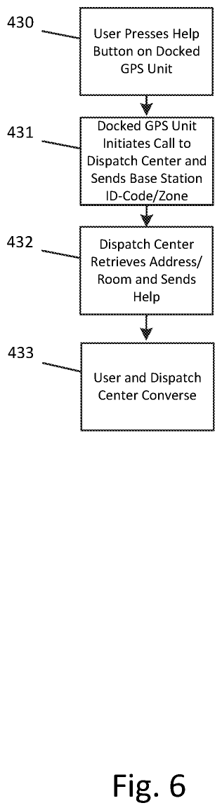

Referring now to FIGS. 1, 2, and 6, alternately, if the user presses help button 101 on docked GPS device 100, docked GPS device 100 causes GPS receiver/cellular transceiver module 108 to initiate a wireless voice call to the dispatch center. The identity of the subscriber is known from the unique phone number and/or account number associated with GPS receiver/cellular transceiver module 108 in GPS device 100. In this case, docked GPS device 100 does not send current geographic coordinates derived from GPS receiver/cellular transceiver module 108. Rather, when this occurs, the database maintained at the dispatch center is accessed using the charging base station ID-code/zone to retrieve the geographic location (address) and zone (kitchen, bath, bedroom) associated with GPS receiver/cellular transceiver module 108 (430, 431). This information is displayed to the dispatcher who then dispatches help to the displayed address referencing the displayed room (432). Since the user would necessarily be in close proximity to GPS device 100, the user and dispatcher can converse as on a conventional speaker phone (433).

In both of the cases described above, the dispatcher will automatically dispatch assistance to the geographic location (address) and zone (kitchen, bath, bedroom, etc.) associated with the phone number associated with GPS receiver/cellular transceiver module 108 whether the user can converse or not.

The forgoing disclosure countenances that the system is used in two basic modes: Where the GPS device 100 and charging base station 200 are docked, or physically connected, and undocked, or physically disconnected. Those having skill in the art will readily appreciate that some characteristics of the operation of the system in the docked mode may be implemented in the undocked mode. For example, if GPS device 100 and charging base station 200 are undocked but close enough so that a wireless connection exists between them, then audio that would ordinarily be reproduced by GPS device 100 when help button 101 or 301 is depressed may be relayed for enhanced volume reproduction to charging base station 200. Of course, in view of the foregoing disclosure GPS device 100 would not be charged by charging base station 200 in this instance. However, one having skill in the art will readily recognize that GPS device 100 and charging base station 200 may incorporate inductive charging circuity/antennas such that the recharging of GPS device 100 may be effectuated at a distance from charging base station 200.

The foregoing disclosure countenances that a cellular wireless telephony system will provide the communications medium whereby GPS device 100 communicates with the dispatch center. This is not perceived as a limitation, however, and any suitable wired or wireless communications network may be substituted, including, but not limited to, Wi-Fi, or any other pico- and micro-cellular data communication system may be employed. Similarly, satellite data communications systems are equally useful.

The foregoing disclosure countenances that the code portion of the zone/code transmitted when the system is used in docked mode will ordinarily indicate that help button 101 on GPS device 100 or wearable personal transmitter 300 has been actuated. It will be readily apparent to those having skill in the art that other codes may be transmitted. For example one, or multiple, codes may indicate battery condition or level in and or all of GPS device 100, charging base station 200, or wearable personal transmitter 300. Similarly, GPS device 100 may transmit codes indicating other button actuations. Similarly, GPS device 100 may transmit codes indicating that GPS device 100 has been docked or undocked from charging base station 200. Similarly, GPS device 100 may transmit codes indicating that signals have been received from ancillary wireless devices, such as, but not limited to: fire alarms, carbon monoxide alarms, flood alarms, power loss alarms, motion sensors, glass breaks, door, window breaks, etc.

The foregoing invention may also include other functionality. For example, a fall or impact detector may be included in GPS device 100 or wearable personal transmitter 300. Such an implementation of the invention would work the same way as if the user pressed help button 101 or 301 on GPS device 100 or wearable personal transmitter 300, respectively, if a preset level of impact occurred. Also, an angle detector might be provided such that excursions beyond a certain angle from vertical would be reported. Such an implementation of the invention would work the same way as if the user pressed help button 101 or 301 on GPS device 100 or wearable personal transmitter 300, respectively, if a preset angular excursion occurred. Similarly, GPS device 100 or wearable personal transmitter 300 may include a user display capable of displaying a variety of information including: 1) The mode the system is in; 2) The signal strength of the cellular system; 3) The status of battery 111 or 304 powering the device; or, 4) Messages sent by the dispatch center.

Also, GPS receiver/cellular transceiver module 108 may include Wi-Fi location services so that a more accurate location may be associated with GPS device 100 when GPS device 100 is shielded from receiving GPS signals. Similarly, 5G base station location services may also be included so that a more accurate location may be associated with GPS device 100 when GPS device 100 is shielded from receiving GPS signals. Both of these implementations would function by directly, or indirectly (by triangulation) locating GPS receiver/cellular transceiver module 108 inside a building or some other enclosed space such as a cavern.

Also, heating element 116 may be installed in GPS device 100 to winterize GPS device 100 to prevent it from being frozen or operating at an excessively low temperature. Also, heating element 116 may be installed to stabilize the temperature of battery 111. This allows battery 111 to be charged to consistently higher levels. Also, heating element 116 may be installed in the outer housing of GPS device 100 such that the hand may be warmed when holding GPS device 100. An externally exposed switch may selectively activate and deactivate heating element 116.

Similarly, heating element 207 may be installed in charging base station 200 to winterize charging base station 200 to prevent it from being frozen or operating at an excessively low temperature. Also, heating element 207 may be installed to stabilize the temperature of battery 205. This allows battery 205 to be charged to consistently higher levels.

Similarly, Bluetooth connectivity between wearable/mobile GPS device 100 and charging base station 200 may be provided so that contactless/wireless 2-way voice connectivity and amplification with charging base station 200 may be achieved. Also, “home” base station location and address confirmation may be managed when multiple charging base stations 200 have been installed in the facility.

Similarly, inductive/wireless recharging of battery 111 used to power GPS device 100 may be performed by charging base station 200.

1. An improved mobile personal response system comprising:
a. a GPS device in cellular communication with a dispatch center, said GPS device further comprising a cellular transceiver, an RF receiver, a GPS receiver, a microphone, a speaker, a source of electrical power, and a switch to cause said GPS device to initiate cellular communication with said dispatch center;
b. a charging base station without an RF transmitter or receiver and further comprising an amplified speaker, an external source of electrical power, and a battery such that when said GPS device and said charging base station are physically affixed to one another that the audible output of said GPS device may be heard through the amplified speaker of said charging base station and the battery in said GPS device may be unswitchedly charged by said external source of electrical power in said charging base station or by said battery in said charging base station when mains voltage is disconnected from said external source of electrical power; and
c. a wearable personal transmitter in RF communication with the RF receiver in said GPS device, said wearable personal transmitter further comprising an RF transmitter, a source of electrical power, and a switch to cause said wearable personal transmitter to initiate RF communication with the RF receiver in said GPS device.

2. An improved mobile personal response system of claim 1 wherein the GPS device has a source of electrical power which is a battery.

3. An improved mobile personal response system of claim 1 wherein the GPS device has a heater element.

4. An improved mobile personal response system of claim 3 wherein the GPS device has a switched heater element which may be configured as a hand warmer.

5. An improved mobile personal response system of claim 1 wherein the charging base station has a source of electrical power which is a battery.

6. An improved mobile personal response system of claim 1 wherein the charging base station has a heater element.

7. An improved mobile personal response system of claim 1 wherein said external source of electrical power is a mains voltage to low voltage power adapter.

8. A method of using an improved mobile personal response system of claim 1 wherein:
a. the user activates said switch on said wearable personal transmitter causing said RF transmitter in said wearable personal transmitter to initiate RF communication with said RF receiver in said GPS device;
b. whereupon, said GPS device causes said cellular transceiver to initiate cellular communication with said dispatch center;
c. whereupon said GPS device sends indicia used to determine the geographic location of said GPS device;
d. whereupon said dispatch center uses said received indicia to determine the geographic location of said GPS device;
e. whereupon said dispatch center dispatches assistance to the determined geographic location; and
f. whereupon said dispatch center verbally communicates with said user.

9. A method of using an improved mobile personal response system of claim 8 wherein said GPS device is not physically affixed to said charging base station and said indicia are the latitude/longitude coordinates derived from said GPS receiver in said GPS device.

10. A method of using an improved mobile personal response system of claim 8 wherein said GPS device is not physically affixed to said charging base station and said verbal communication with said user is output by said speaker in said GPS unit.

11. A method of using an improved mobile personal response system of claim 8 wherein said GPS device is physically affixed to said charging base station and the indicia is the phone number of said cellular transceiver in said GPS device.

12. A method of using an improved mobile personal response system of claim 11 wherein said indicia comprising said phone number of said cellular transceiver in said GPS device is used to retrieve the user's address and code/zone from a pre-created database.

13. A method of using an improved mobile personal response system of claim 12 wherein said code/zone represents a room or other location associated with said address.

14. A method of using an improved mobile personal response system of claim 8 wherein said GPS device is physically affixed to said charging base station and said verbal communication with said user is output by said amplified speaker in said charging base station.
